(19) United States
(12) Patent Application Publication
(10) Pub. No.: US 2025/0333638 A1
(43) Pub. Date: Oct. 30, 2025

(54) SOLVENTS FOR CONTAINER APPLICATION OF OILFIELD PRODUCTS

(71) Applicant: ChampionX LLC, Sugar Land, TX (US)

(72) Inventors: Jeremy MOLONEY, Katy, TX (US); Tri PHAN, Rosenberg, TX (US); Gedeng RUAN, Houston, TX (US)

(73) Assignee: ChampionX LLC, Sugar Land, TX (US)

(21) Appl. No.: 19/187,118

(22) Filed: Apr. 23, 2025

Related U.S. Application Data
(60) Provisional application No. 63/638,759, filed on Apr. 25, 2024.

(51) Int. Cl. C09K 8/54

(52) U.S. Cl. CPC C09K 8/54; C09K 2208/32

(57) ABSTRACT

A water-soluble container including a treatment chemical is provided. The treatment chemical may be, for example, an organic sulfur compound, an imidazoline, a carboxylic acid, a fatty acid amine condensate, a substituted fatty acid ester, a substituted aromatic amine, a phosphoric acid ester, a quaternary ammonium compound, a compound having multiple positive charges, or any combination of these chemicals. The water-soluble container may include, for example, cellulose, polyvinyl alcohol, gelatin, or any combination of these materials.

### TECHNICAL FIELD

The present disclosure generally relates to chemical treatment compositions, products incorporating such compositions, and methods of using and preparing the same.

### BACKGROUND

To meet the significant growth in oil and gas demand today, exploration is moving to uncharted, ultra-deep water locations and production is being considered in locations previously considered to be off-limits. Further, much of the existing infrastructure typically operates well beyond its designed capabilities. This overreach creates significant technical challenges in all areas of production; however, no challenge is more difficult than preserving infrastructure integrity.

Corrosion inhibitors and other treatment chemicals are frequently introduced into oil and gas fluids to aid in maintaining infrastructure integrity. Corrosion inhibitors are added to a wide array of systems and system components, such as cooling systems, refinery units, pipelines, steam generators, and oil or gas producing and production water handling equipment. These corrosion inhibitors are geared towards combating a large variety of corrosion types. For example, a common type of corrosion encountered in well bores is acid induced corrosion where the degree of corrosion depends on a multitude of factors. These factors include, for example, the corrosiveness of the fluid, pipeline metallurgy, temperature, time of corrosive fluid contact time, and pressure.

Typically, oilfield treatment chemicals, such as corrosion inhibitors, are injected in a liquid form into a production well or pipeline. This relies upon there being the required infrastructure such as chemical tanks, skids, pumps, and the like. However, for production facilities and pipelines without such infrastructure the application of usual treatment chemicals is more challenging. The primary option available to an operator is either not to treat their facility or to spend significant resources to enable the application of liquid products.

### BRIEF SUMMARY

The present disclosure provides containers comprising treatment chemicals, methods of manufacturing the containers, and methods of using the containers.

In some embodiments, a water-soluble container of the present disclosure comprises a composition comprising a treatment chemical and a solvent selected from the group consisting of isopropyl alcohol, acetone, ethylene glycol monobutyl ether (EGMBE), 2-ethyl hexanol, kerosene, xylene, heavy aromatic naphtha, light aromatic naphtha, mineral oil, toluene, diesel, propylene glycol, diethylene glycol, and any combination thereof, wherein the water-soluble container comprises a polyvinyl alcohol.

In certain embodiments, the present disclosure provides a water-soluble container comprising a composition comprising a treatment chemical and a solvent selected from the group consisting of isopropyl alcohol, acetone, EGMBE, 2-ethyl hexanol, kerosene, xylene, heavy aromatic naphtha, light aromatic naphtha, mineral oil, toluene, diesel, propylene glycol, diethylene glycol, ethanol, and any combination thereof, wherein the water-soluble container comprises gelatin.

In some embodiments, a water-soluble container of the present disclosure comprises a composition comprising a treatment chemical and a solvent selected from the group consisting of isopropyl alcohol, light aromatic naphtha, mineral oil, toluene, and any combination thereof, wherein the water-soluble container comprises cellulose.

The present disclosure also provides a method of treating a subterranean reservoir. The method comprises adding any of the water-soluble containers disclosed herein to the subterranean reservoir.

Additionally, the present disclosure provides a method of treating a pipeline. The method comprises adding any of the water-soluble containers disclosed herein to the pipeline.

Finally, the present disclosure provides a method of preparing a product comprising providing a water-soluble container, adding a treatment chemical to the water-soluble container, adding a solvent to the water-soluble container, and sealing the container, wherein the container is stable for at least about 48 hours.

The foregoing has outlined rather broadly the features and technical advantages of the present disclosure in order that the detailed description that follows may be better understood. Additional features and advantages of the disclosure will be described hereinafter that form the subject of the claims of this application. It should be appreciated by those skilled in the art that the conception and the specific embodiments disclosed may be readily utilized as a basis for modifying or designing other embodiments for carrying out the same purposes of the present disclosure. It should also be realized by those skilled in the art that such equivalent embodiments do not depart from the spirit and scope of the disclosure as set forth in the appended claims.

### DETAILED DESCRIPTION

Various embodiments are described below. The relationship and functioning of the various elements of the embodiments will be better understood in light of the following detailed description. However, elements and embodiments are not strictly limited to those explicitly described below.

Examples of methods and materials are described below, although methods and materials similar or equivalent to those described herein can be used in practice or testing of the present disclosure. All publications, patent applications, patents and other reference materials mentioned herein are incorporated by reference in their entirety. The materials, methods, and examples disclosed herein are illustrative only and not intended to be limiting.

Unless otherwise defined, all technical and scientific terms used herein have the same meaning as commonly understood by one of ordinary skill in the art. In case of conflict, the present document, including definitions, will control.

Unless otherwise indicated, an alkyl group as described herein alone or as part of another group is an optionally substituted linear or branched saturated monovalent hydrocarbon substituent containing from, for example, one to about sixty carbon atoms, such as one to about thirty carbon atoms, in the main chain. Examples of unsubstituted alkyl groups include methyl, ethyl, n-propyl, i-propyl, n-butyl, i-butyl, s-butyl, t-butyl, n-pentyl, i-pentyl, s-pentyl, t-pentyl, and the like.

The terms “aryl” or “ar” as used herein alone or as part of another group (e.g., arylene) denote optionally substituted homocyclic aromatic groups, such as monocyclic or bicyclic groups containing from about 6 to about 12 carbons in the ring portion, such as phenyl, biphenyl, naphthyl, substituted phenyl, substituted biphenyl or substituted naphthyl. The term “aryl” also includes heteroaryl functional groups. It is understood that the term “aryl” applies to cyclic substituents that are planar and comprise 4n+2 electrons, according to Huckel's Rule.

“Cycloalkyl” refers to a cyclic alkyl substituent containing from, for example, about 3 to about 8 carbon atoms, such as from about 4 to about 7 carbon atoms or about 4 to 6 carbon atoms. Examples of such substituents include cyclopropyl, cyclobutyl, cyclopentyl, cyclohexyl, cycloheptyl, cyclooctyl, and the like. The cyclic alkyl groups may be unsubstituted or further substituted with alkyl groups, such as methyl groups, ethyl groups, and the like.

“Heteroaryl” refers to a monocyclic or bicyclic 5- or 6-membered ring system, wherein the heteroaryl group is unsaturated and satisfies Huckel's rule. Non-limiting examples of heteroaryl groups include furanyl, thiophenyl, pyrrolyl, pyrazolyl, imidazolyl, 1,2,3-triazolyl, 1,2,4-triazolyl, isoxazolyl, oxazolyl, isothiazolyl, thiazolyl, 1,3,4-oxadiazol-2-yl, 1,2,4-oxadiazol-2-yl, 5-methyl-1,3,4-oxadiazole, 3-methyl-1,2,4-oxadiazole, pyridinyl, pyrimidinyl, pyrazinyl, triazinyl, benzofuranyl, benzothiophenyl, indolyl, quinolinyl, isoquinolinyl, benzimidazolyl, benzoxazolinyl, benzothiazolinyl, quinazolinyl, and the like.

Compounds of the present disclosure may be substituted with suitable substituents. The term “suitable substituent,” as used herein, is intended to mean a chemically acceptable functional group, preferably a moiety that does not negate the activity of the compounds. Such suitable substituents include, but are not limited to, halo groups, perfluoroalkyl groups, perfluoro-alkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, HO—(C═O)— groups, heterocylic groups, cycloalkyl groups, amino groups, alkyl- and dialkylamino groups, carbamoyl groups, alkylcarbonyl groups, alkoxycarbonyl groups, alkylaminocarbonyl groups, dialkylamino carbonyl groups, arylcarbonyl groups, aryloxy-carbonyl groups, alkylsulfonyl groups, and arylsulfonyl groups. In some embodiments, suitable substituents may include halogen, an unsubstituted C₁-C₁₂ alkyl group, an unsubstituted C₄-C₆ aryl group, or an unsubstituted C₁-C₁₀ alkoxy group. Those skilled in the art will appreciate that many substituents can be substituted by additional substituents.

The term “substituted” as in “substituted alkyl,” means that in the group in question (e.g., the alkyl group), at least one hydrogen atom bound to a carbon atom is replaced with one or more substituent groups, such as hydroxy (—OH), alkylthio, phosphino, amido (—CON(R_{A})(R_{B}), wherein R_{A} and R_{B} are independently hydrogen, alkyl, or aryl), amino(—N(R_{A})(R_{B}), wherein R_{A} and R_{B} are independently hydrogen, alkyl, or aryl), halo (fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like.

When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

The terms “polymer,” “copolymer,” “polymerize,” “copolymerize,” and the like include not only polymers comprising two monomer residues and polymerization of two different monomers together, but also include (co)polymers comprising more than two monomer residues and polymerizing together more than two or more other monomers. For example, a polymer as disclosed herein includes a terpolymer, a tetrapolymer, polymers comprising more than four different monomers, as well as polymers comprising, consisting of, or consisting essentially of two different monomer residues. Additionally, a “polymer” as disclosed herein may also include a homopolymer, which is a polymer comprising a single type of monomer unit.

Unless specified differently, the polymers of the present disclosure may be linear, branched, crosslinked, structured, synthetic, semi-synthetic, natural, and/or functionally modified. A polymer of the present disclosure can be in the form of a solution, a dry powder, a liquid, or a dispersion, for example.

The present disclosure provides water-soluble containers for various compounds and/or compositions. The water-soluble containers eliminate the need for infrastructure that is typically required for liquid chemical application.

A composition of the present disclosure may include a treatment chemical and a solvent, among other optional components. The water-soluble container may comprise various materials that dissolve, or at least partially dissolve, in water, such as polyvinyl alcohol, gelatin, cellulose, or any combination thereof. Suitable materials include, for example, paper, board stock, cardboard, corrugate, or any combination thereof.

The term “water-soluble,” as used herein, refers to the capability of being at least partially soluble and subsequently partially dispersible (e.g., at least about 70% dispersible) to nearly completely dispersible (e.g., about 100% dispersible) in an aqueous solution, such as water. Contacting the water-soluble container can result in fragmentation of the composition into particulates and/or micro-particulates, where a water-dispersible layer or sheet can form such particulates in an aqueous solution. Water-soluble materials, as referenced herein, include materials and papers referred to in the art as “water-soluble,” where only a portion of the paper may be actually soluble in water, but dissolution of this soluble portion results in dispersion of most or all of the remaining structure.

A composition or treatment chemical disclosed herein may be oil-soluble or water-soluble. In some embodiments, a composition or treatment chemical may be anhydrous.

Treatment chemicals of the present disclosure include, but are not limited to, a hydrate inhibitor, an asphaltene inhibitor, a paraffin inhibitor, a demulsifier, a biocide, a scale inhibitor, a corrosion inhibitor, and any combination thereof.

A hydrate inhibitor may include, for example, a mono-alkyl amide, a di-alkyl amide, an alkyl quaternary ammonium salt, and any combination thereof.

An asphaltene inhibitor may include, for example, an alkylphenol/formaldehyde resin, a polyisobutylene esters, a polyisobutylene imides, a polyalkyl acrylate, and any combination thereof.

A paraffin inhibitor may include, for example, a polyalkyl acrylate, an olefin/maleic anhydride polymer, and any combination thereof.

A demulsifier may include, for example, acrylic acid, a polymer comprising T-butylphenol, an ethylene oxide (EO) polymer, a propylene oxide (PO) polymer, formaldehyde, maleic anhydride, 4-nonylphenol, propenoic acid, a polymer comprising 2,5-furandione, methyloxirane and/or oxirane, and a reaction product of EO, PO, 4-nonylphenol, formaldehyde, maleic anhydride, and acrylic acid.

A biocide may include, for example, glutaraldehyde, tetrakis(hydroxymethyl)phosphonium sulphate, a quaternary ammonium compound, chlorine, hypochlorite, ClO₂, bromine, ozone, hydrogen peroxide, peracetic acid, peroxycarboxylic acid, peroxycarboxylic acid composition, peroxysulphate, glutaraldehyde, dibromonitrilopropionamide, isothiazolone, terbutylazine, polymeric biguanide, methylene bisthiocyanate, tetrakis hydroxymethyl phosphonium sulphate, and any combination thereof.

A scale inhibitor may include, for example, a phosphonate, a sulfonate, a phosphate, a phosphate ester, a polymer comprising a phosphonate or phosphonate ester group, a polymeric organic acid, a peroxycarboxylic acid, and any combination thereof. In some embodiments, the scale inhibitor may be selected from a compound comprising an amine and/or a quaternary amine, nitrilotriacetic acid (NTA), ethylenediaminetetraacetic acid (E DTA), diethylenetriamine (DETA) phosphonate, and any combination thereof.

In some embodiments, the scale inhibitor is an acid-based scale inhibitor, such as phosphonic acid. In some embodiments, the scale inhibitor comprises an anionic group. The anionic group may comprise, for example, a carboxylate group or a sulfate group. In some embodiments, the scale inhibitor may include a phosphorous atom, a phosphorous-oxygen double bond, and/or a phosphono group.

In some embodiments, the scale inhibitor is selected from the group consisting of hexamethylene diamine tetrakis (methylene phosphonic acid), diethylene triamine tetra (methylene phosphonic acid), diethylene triamine penta (methylene phosphonic acid), polyacrylic acid (PAA), phosphino carboxylic acid (PPCA), diglycol amine phosphonate (DGA phosphonate), 1-hydroxyethylidene 1,1-diphosphonate (HE DP phosphonate), bisaminoethylether phosphonate (BAEE phosphonate), 2-acrylamido-2-methyl-1-propanesulphonic acid (AMPS), and any combination thereof.

In certain embodiments, the scale inhibitor is a polymer comprising an anionic monomer. The anionic monomer may be selected from, for example, acrylic acid, methacrylic acid, vinyl sulfonic acid, vinyl phosphonic acid, maleic anhydride, itaconic acid, crotonic acid, maleic acid, fumaric acid, styrene sulfonic acid, and any combination thereof.

Additional non-limiting examples of treatment chemicals include an organic sulfur compound, an imidazoline, a carboxylic acid, a fatty acid amine condensate, a substituted fatty acid ester, a substituted aromatic amine, a phosphoric acid ester, a quaternary ammonium compound, or a compound comprising multiple positive charges.

The compound comprising multiple positive charges may be derived from a polyamine through its reactions with an activated olefin and an epoxide, wherein the activated olefin has the following formula:

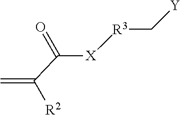

wherein X is NH or O; R² is H, CH₃, or an unsubstituted, linear or branched C₂-C₁₀ alkyl, alkenyl, or alkynyl group; R³ is absent or an unsubstituted, linear C₁-C₃₀ alkylene group; Y is —NR₄R₅R₆⁽⁺⁾; R⁴, R⁵, and R⁶ are independently a C₁-C₁₀ alkyl group; wherein the epoxide has the following formula;

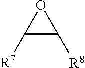

R⁷ is H or alkyl; and R⁸ is alkyl, or —(CH₂)ₖ—O-alkyl, wherein k is an integer of 1-30; wherein the polyamine and activated olefin undergo aza Michael Addition reaction and the polyamine and epoxide undergo ring opening reaction. In some embodiments, the compound comprises a nonionic group.

In some embodiments, the compound has one of the generic formula of NA₂-[R^{10′}]ₙ—NA₂, (RNA)ₙ-RNA₂, NA₂-(RNA)ₙ-RNA₂, or NA₂-(RN(R′))ₙ-RNA₂, wherein R^{10′} is a linear or branched, unsubstituted or substituted C₂-C₁₀ alkylene group, or combination thereof; R is —CH₂—, —CH₂CH₂—, —CH₂CH₂CH₂—, —CH(CH₃)CH₂—, a linear or branched, unsubstituted or substituted C₄-C₁₀ alkylene group, or combination thereof; R′ is —CH₂—, —CH₂CH₂—, —CH₂CH₂CH₂—, —CH(CH₃)CH₂—, a linear or branched, unsubstituted or substituted C₄-C₁₀ alkyl group, RNAB, RNARNAB, or RN(RNAB)₂; n can be from 2 to 1,000,000; A is a combination of H,

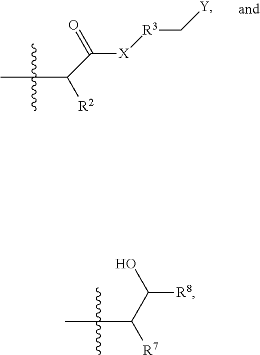

wherein X is NH or O; R² is H, CH₃, or an unsubstituted, linear or branched C₂-C₁₀ alkyl, alkenyl, or alkynyl group; R³ is absent or an unsubstituted, linear C₁-C₃₀ alkylene group; Y is —NR₄R₅R₆⁽⁺⁾; R⁴, R⁵, and R⁶ are independently a C₁-C₁₀ alkyl group; R⁷ is H or alkyl; and R⁸ is alkyl, or —(CH₂)ₖ—O-alkyl, wherein k is an integer of 1-30.

The compound may be a multiple charged cationic compound having a

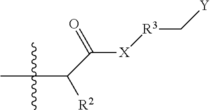

group and a

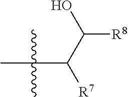

group.

The treatment chemical may comprise, for example, 2-mercaptoethanol, a DETA:TOFA imidazoline, a reaction product of TEA and TOFA, a reaction product of TOFA and TEPA, an alkyl pyridine, an ethoxylated branched nonylphenol phosphate ester, a benzy-(C₁₂ to C₁₈ linear alkyl)-dimethylammonium chloride, 5-carboxy-4-hexyl-2-cyclohexene octanoic acid, 6-carboxy-4-hexyl-2-cyclohexene octanoic acid, maleated TOFA, an acrylated DETA:TOFA imidazoline, and any combination thereof.

In some embodiments, a treatment chemical is selected from the group consisting of a fouling control agent, a corrosion inhibitor, a corrosion inhibitor intensifier, a biocide, a preservative, an acid, a hydrogen sulfide scavenger, a surfactant, an asphaltene inhibitor, a paraffin inhibitor, a scale inhibitor, a gas hydrate inhibitor, a pH modifier, an emulsion breaker, a reverse emulsion breaker, a coagulant/flocculant agent, an emulsifier, a water clarifier, a dispersant, an antioxidant, a polymer degradation prevention agent, a permeability modifier, a foaming agent, an antifoaming agent, a CO₂ scavenger, an O₂ scavenger, a gelling agent, a lubricant, a friction reducing agent, a salt, a clay stabilizer, a bactericide, a salt substitute, a relative permeability modifier, a breaker, a fluid loss control additive, a chelating agent, a demulsifier, an iron control agent, a drag reducing agent, a flow improver, a viscosity reducer, a solvent, and any combination thereof.

The fouling control agent may comprise, for example, a quaternary compound.

The acid may comprise, for example, hydrochloric acid, hydrofluoric acid, citric acid, formic acid, acetic acid, or any combination thereof.

The hydrogen sulfide scavenger may comprise, for example, an oxidant, inorganic peroxide, chlorine dioxide, a C₁-C₁₀ aldehyde, formaldehyde, glyoxal, glutaraldehyde, acrolein, methacrolein, a triazine, or any combination thereof.

Illustrative examples of corrosion inhibitors include imidazoline compounds, such as those having the following structure:

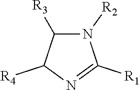

wherein R₁ is a C₁ to C₂₃ alkyl group or a C₁ to C₂₃ alkenyl group; R₃ and R₄ are independently hydrogen or a C₁ to C₆ alkyl group; R₂ is a C₁ to C₆ alkyl group, optionally substituted with —N(R₅)(R₆) or —C(O)OR₇; R₅ and R₆ are independently hydrogen or —C(O)R₈; R₇ is a C₁₀ to C₂₀ alkyl group or a C₁₀ to C₂₀ alkenyl group; and R₈ is hydrogen or C₁ to C₆ alkyl; or a tautomer thereof.

Additional examples of corrosion inhibitors include quaternary ammonium compounds, such as those having the following structure:

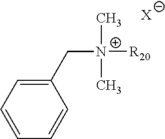

wherein R₂₀ is a C₆ to C₂₀ alkyl group, a C₆ to C₂₀ alkenyl group, or a C₆ to C₂₀ alkyl group, wherein one or more —CH₂— is replaced with —O—.

Still further examples include a mixture of dimerized fatty acids and/or trimerized fatty acids; a reaction product of a polyalkylenepolyamine and a fatty acid; a C₁₈ unsaturated dimer; a maleated fatty acid; a tall oil fatty acid; an alkanolamine; or an alkoxylated unsaturated fatty acid dimer.

The solvents that may be used in connection with the compositions and water-soluble containers of the present disclosure include, but are not limited to, isopropyl alcohol, acetone, ethylene glycol monobutyl ether (EGMBE), 2-ethyl hexanol, kerosene, xylene, heavy aromatic naphtha, light aromatic naphtha, mineral oil, toluene, diesel, propylene glycol, diethylene glycol, ethanol, and any combination thereof.

The present inventors discovered that certain solvents may advantageously be chosen depending upon the material(s) of the water-soluble container. For example, if the container comprises a polyvinyl alcohol, a solvent may be selected from isopropyl alcohol, acetone, ethylene glycol monobutyl ether (EGMBE), 2-ethyl hexanol, kerosene, xylene, heavy aromatic naphtha, light aromatic naphtha, mineral oil, toluene, diesel, propylene glycol, diethylene glycol, and any combination thereof.

If a container comprises gelatin, the solvent may be selected from, for example, isopropyl alcohol, acetone, EGMBE, 2-ethyl hexanol, kerosene, xylene, heavy aromatic naphtha, light aromatic naphtha, mineral oil, toluene, diesel, propylene glycol, diethylene glycol, ethanol, and any combination thereof.

If a container comprises cellulose, the solvent may be selected from, for example, isopropyl alcohol, light aromatic naphtha, mineral oil, toluene, and any combination thereof.

The compositions of the present disclosure may be in any form, such as liquid, solid, or a combination thereof. The solid form treatment chemicals may comprise, for example, a powder, a tablet, a puck, a pellet, a stick, a rod, a snake, a block, a marble, any other geometrical shape, or any combination thereof.

In addition to a treatment chemical, a powder of the present disclosure may include sodium bicarbonate, calcium carbonate, citric acid, oxalic acid, palmitic acid, tartaric acid, maleic acid, or any combination thereof. In some instances, the geometrical shape (e.g., tablet, pellet, marble, etc.) may be prepared by molding a powder. In such cases, the amount of powder in the geometrical shape (excluding the treatment chemical) may be from about 40 wt % to about 99 wt %. In some aspects, the amount of powder (excluding the treatment chemical) may be from about 50 wt % to about 99 wt %, from about 60 wt % to about 99 wt %, from about 70 wt % to about 99 wt %, from about 80 wt % to about 99 wt %, or from about 90 wt % to about 99 wt %.

The amount of treatment chemical in the geometrical shape may range from, for example, about 1 wt % to about 100 wt %, such as about 5 wt % to about 100 wt %, about 10 wt % to about 100 wt %, about 20 wt % to about 100 wt %, about 30 wt % to about 100 wt %, about 40 wt % to about 100 wt %, about 50 wt % to about 100 wt %, about 60 wt % to about 100 wt %, about 70 wt % to about 100 wt %, about 80 wt % to about 100 wt %, about 90 wt % to about 100 wt %, about 1 wt % to about 90 wt %, about 1 wt % to about 80 wt %, about 1 wt % to about 70 wt %, about 1 wt % to about 60 wt %, about 1 wt % to about 50 wt %, about 1 wt % to about 40 wt %, about 1 wt % to about 30 wt %, about 1 wt % to about 20 wt %, about 1 wt % to about 10 wt %, about 65 wt % to about 95 wt %, about 70 wt % to about 95 wt %, about 75 wt % to about 95 wt %, or about 80 wt % to about 95 wt %.

The overall size of the tablet, puck, pellet, stick, rod, snake, block, marble, or other suitable geometrical shape is not particularly limited and may be chosen, for example, based on the intended application or the size of the water-soluble container. In some embodiments, the size may range from about 1 gram to about 1 kg or more if desired. In some embodiments, the size is from about 1 gram to about 5 grams, about 1 gram to about 25 grams, about 1 gram to about 50 grams, about 1 gram to about 100 grams, about 1 gram to about 250 grams, about 1 gram to about 500 grams, about 1 gram to about 750 grams, about 50 grams to about 1 kg, about 100 grams to about 1 kg, about 300 grams to about 1 kg, about 500 grams to about 1 kg, about 750 grams to about 1 kg, or any amount greater than 1 kg or less than 1 gram.

Additionally, the tablet, puck, pellet, marble, etc., may have a ratio ranging from about 1:10 to about 10:1 (diameter:depth/length), such as from about 1:7, about 1:5, about 1:3, about 1:1, about 3:1, about 5:1, or about 7:1. The ratio could be larger or smaller, however, such as from 1:50, 1:100, etc., or 50:1, 100:1, etc.

In some embodiments, a tablet (or other shape) may have a length, width, and/or depth ranging from about 0.5 inches (or less) to about 12 inches (or more), such as from about 0.5 inches to about 1 inch, about 0.5 inches to about 2 inches, about 0.5 inches to about 3 inches, about 0.5 inches to about 4 inches, about 0.5 inches to about 5 inches, about 0.5 inches to about 6 inches, about 0.5 inches to about 7 inches, about 0.5 inches to about 8 inches, or about 0.5 inches to about 9 inches.

If a marble, sphere, or other circular shape is selected, the shape may have any desirable diameter, such as from about 0.5 inches (or less) to about 12 inches (or more), such as from about 1 inch to about 12 inches, about 2 inches to about 12 inches, about 3 inches to about 12 inches, about 4 inches to about 12 inches, about 5 inches to about 12 inches, about 6 inches to about 12 inches, about 7 inches to about 12 inches, about 8 inches to about 12 inches, about 9 inches to about 12 inches, about 10 inches to about 12 inches, or about 11 inches to about 12 inches.

The water-soluble container may be constructed from one or more water-dispersible and/or biodegradable materials. For example, the container may have a first layer comprising a water-soluble material and a second layer comprising a biodegradable material. Any suitable number of layers may be chosen and each layer may be independently selected from, for example, a water-soluble layer, an oil-soluble layer, a biodegradable layer, etc. Based on the different number of layers and different type of layers, the timing of chemical release may be controlled.

The term “biodegradable,” as used herein, refers to materials that can be readily decomposed by biological methods, through a combination of heat, moisture, and/or microbial action.

Additionally, a layer of the container may have a specific thickness to control the timing of release of the treatment chemical contained therein. A container may also have various compartments, such as one, two, three, four, five, or more isolated and independent compartments, and each compartment may have a treatment chemical. The wall thickness of each compartment may be the same or different. As an illustrative example, if a container has two separate compartments, each compartment is constructed from the same material, such as cellulose but each compartment has a different wall thickness, then the treatment chemical housed in the compartment with the thinner wall thickness will be released before the treatment chemical housed in the compartment that has the thicker wall thickness.

For example, a water-soluble container comprising gelatin having a wall thickness of about 10 mm will dissolve faster than a water-soluble container comprising gelatin having a wall thickness of about 1 inch.

The thickness of a wall (regardless of the number of layers it may comprise) can be selected based on the intended application and the desired release time of the treatment chemical. For example, a wall thickness may be form about 10 μm to about 10 cm, such as from about 10 μm to about 5 cm, about 10 μm to about 1 cm, about 10 μm to about 1,000 μm, about 10 μm to about 800 μm, about 10 μm to about 600 μm, about 10 μm to about 400 μm, about 10 μm to about 200 μm, about 10 μm to about 100 μm, about 10 μm to about 50 μm, about 20 μm to about 50 μm, about 20 μm to about 100 μm, about 20 μm to about 150 μm, or about 20 μm to about 200 μm.

A water-soluble container may optionally include, a water-soluble weighting agent, particularly if the container comprises a liquid composition. Examples of weighting agent include, but are not limited to, sodium chloride, sodium bromide, sodium iodide, calcium chloride, calcium bromide, or calcium iodide. In some aspects, the weighting agent comprises sodium chloride.

An amount of liquid composition and/or treatment chemical in the water-soluble container is not particularly limited and may be chosen, for example, based on the intended application. In some embodiments, the amount may range from about 1 ml to about 5 L or more if desired. For example, the mount may range from about 1 ml to about 10 ml, about 1 ml to about 50 ml, about 1 ml to about 100 ml, about 1 ml to about 500 ml, about 1 ml to about 1 L, about 1 ml to about 3 L, about 100 ml to about 5 L, about 500 ml to about 5 L, about 1 L to about 5 L, or about 3 L to about 5 L.

The present disclosure also provides methods of treating a subterranean reservoir. The methods comprise adding any water-soluble container disclosed herein to the subterranean reservoir and/or to a medium in the subterranean reservoir. In some embodiments, the water-soluble container may be added to a wellhead, a medium in the wellhead, a storage vessel, a medium in the storage vessel, a pipeline, a medium in the pipeline, or any combination thereof.

Addition to wellhead includes, for example, addition to a tubing at the wellhead, addition to a casing at the wellhead, and/or addition to an annular space between tubing and casing.

The container may be added continuously, intermittently, automatically, and/or manually.

As an illustrative example, a container and/or treatment chemical disclosed herein may be used in connection with a passive elution system that includes an elution device defining an interior volume having an outlet therefrom, the outlet situated at or near the bottom of the elution device, where the interior volume includes the treatment chemical and/or container. The system also includes a conduit in fluid communication with the outlet and arranged and adapted to receive a produced fluid flow from a wellbore of a subterranean reservoir at a location above the surface of the earth, direct the produced fluid flow to provide an eluting contact with the treatment chemical/container to form a treated produced fluid flow, and direct the treated produced fluid flow into the wellbore.

An additional example of a passive elution system that may be used in accordance with the presently disclosed treatment chemicals and containers includes an elution device defining an interior volume having an inlet and an outlet, where the inlet is situated on or near the top of the elution device during operation of the passive elution system, and the outlet is situated on or near to the bottom of the elution device during operation of the passive elution system. The interior volume includes a treatment chemical and/or container. The system also includes a first conduit in fluid communication with the inlet and arranged and adapted to receive a produced fluid flow from a wellbore of a subterranean reservoir at a location above the surface of the earth, and direct the produced fluid flow through the inlet to provide an eluting contact with the treatment material to form a treated produced fluid. Additionally, the system includes a second conduit in fluid communication with the outlet and arranged and adapted to receive the treated produced fluid and direct the treated produced fluid into the wellbore.

In addition to being situated on or above the surface of the earth, an elution device of a passive elution system disclosed herein may be operably situated proximal to the wellhead of a producing wellbore and configured to passively receive or obtain a side stream of a produced fluid therefrom as the produced fluid flows upwards from within the wellbore to reach the wellhead area located at or near the surface of the earth. The conduit of the passive elution system is fluidly connected, at a location at or above the surface of the earth, to a source of produced fluid flowing from the wellbore; and configured to passively receive a side stream flow of the produced fluid, direct the side stream to provide an eluting contact with the treatment chemical/container of the elution device to form a treated produced fluid flow, and direct the treated produced fluid flow into the wellbore of the subterranean reservoir.

Accordingly, the passive elution systems do not require external or applied sources of power to obtain operability. That is, the passive elution systems operate by directing a fluid flow, and do not require external or applied sources of power to cause or direct fluid flow through the passive elution system. Instead, the passive elution systems are designed and configured to passively receive a produced fluid flow from a wellbore, direct the produced fluid flow into an eluting contact with a treatment chemical and/or container to form a treated produced fluid flow, and direct the treated produced fluid flow into the wellbore.

In some aspects, the effective amount of the treatment chemical added to the medium is from about 1 ppm to about 10,000 ppm. Any number of water-soluble containers comprising a treatment chemical may be added to attain the desired amount of treatment chemical. For example, the effective amount may be from about 1 ppm to about 5,000 ppm, from about 1 ppm to about 4,000 ppm, from about 1 ppm to about 3,000 ppm, from about 1 ppm to about 2,000 ppm, from about 1 ppm to about 1,000 ppm, from about 1 ppm to about 500 ppm, from about 1 ppm to about 250 ppm, from about 1 ppm to about 100 ppm, from about 100 ppm to about 1,000 ppm, or from about 100 ppm to about 500 ppm.

The containers and methods disclosed herein may be useful while carrying out various processes in an the oil & gas operation but the containers and methods may be used in processes from other industries, such as water treatment, geothermal, nuclear, etc.

In an illustrative embodiment, a method of treating a subterranean reservoir may comprise inhibiting corrosion of a metallic surface present in the subterranean reservoir or a metallic surface of a pipeline used to transport a hydrocarbon. The methods may include adding any container disclosed herein to a subterranean reservoir, a medium in the subterranean reservoir, a wellhead, a medium in the wellhead, a storage vessel, a medium in the storage vessel, a pipeline, a medium in the pipeline, or any combination thereof.

A medium disclosed herein may comprise, for example, a hydrocarbon (in liquid and/or gaseous form), water, or any combination thereof.

The methods are useful for inhibiting corrosion of metal surfaces in contact with any type of corrodent in the medium, such as metal cations, metal complexes, metal chelates, organometallic complexes, aluminum ions, ammonium ions, barium ions, chromium ions, cobalt ions, cuprous ions, cupric ions, calcium ions, ferrous ions, ferric ions, hydrogen ions, magnesium ions, manganese ions, molybdenum ions, nickel ions, potassium ions, sodium ions, strontium ions, titanium ions, uranium ions, vanadium ions, zinc ions, bromide ions, carbonate ions, chlorate ions, chloride ions, chlorite ions, dithionate ions, fluoride ions, hypochlorite ions, iodide ions, nitrate ions, nitrite ions, oxide ions, perchlorate ions, peroxide ions, phosphate ions, phosphite ions, sulfate ions, sulfide ions, sulfite ions, hydrogen carbonate ions, hydrogen phosphate ions, hydrogen phosphite ions, hydrogen sulfate ions, hydrogen sulfite ions, an acid, such as carbonic acid, hydrochloric acid, nitric acid, sulfuric acid, nitrous acid, sulfurous acid, a peroxy acid, or phosphoric acid, ammonia, bromine, carbon dioxide, chlorine, chlorine dioxide, fluorine, hydrogen chloride, hydrogen sulfide, iodine, nitrogen dioxide, nitrogen monoxide, oxygen, ozone, sulfur dioxide, hydrogen peroxide, polysaccharides, metal oxides, sands, clays, silicon dioxide, titanium dioxide, muds, insoluble inorganic and/or organic particulates, an oxidizing agent, a chelating agent, an alcohol, and any combination of the foregoing.

The presently disclosed containers comprising corrosion inhibitors are useful for inhibiting corrosion of surfaces comprising any metal or combination of metals. In some aspects, the metal surface comprises steel, such as stainless steel or carbon steel. In some aspects, the metal surface comprises iron, aluminum, zinc, chromium, manganese, nickel, tungsten, molybdenum, titanium, vanadium, cobalt, niobium, or copper. The metal surface may also comprise any combination of the foregoing metals and/or any one or more of boron, phosphorus, sulfur, silicon, oxygen, and nitrogen. In some aspects, a pipe or a tank (e.g., railroad tank car or a tank truck/tanker) comprises the metal surface.

The present disclosure also provides methods of manufacturing the container products disclosed herein. A method of preparing a product may include, for example, providing a water-soluble container, adding any treatment chemical disclosed herein to the water-soluble container, adding a solvent to the water-soluble container, and sealing the container. Sealing may be accomplished by any means known in the art, such as through the use of heat and/or compression, an adhesive, such as any adhesive known to adhere paper, gelatin, and/or polyvinyl alcohol, etc. If a compatible solvent is chosen, the container is stable for at least about 48 hours, such as about 48 hours to 1 week, about 48 hours to about 1 month, about 48 hours to about 3 months, about 48 hours to about 6 months, about 48 hours to about 1 year, about 1 week to about 1 year, about 1 month to about 1 year, about 3 months to about 1 year, or about 6 months to about 1 year. In accordance with the present disclosure, “stable” means that no solvent and/or treatment chemical escapes/leaks from the container. The integrity of the container is not compromised by the solvent and/or treatment chemical. The container is not degraded or dissolved by the solvent and/or treatment chemical.

In some embodiments, the solvent is selected from the group consisting of isopropyl alcohol, acetone, ethylene glycol monobutyl ether (EGMBE), 2-ethyl hexanol, kerosene, xylene, heavy aromatic naphtha, light aromatic naphtha, mineral oil, toluene, diesel, propylene glycol, diethylene glycol, and any combination thereof, and the water-soluble container comprises a polyvinyl alcohol.

In certain embodiments, the solvent is selected from the group consisting of isopropyl alcohol, acetone, EGMBE, 2-ethyl hexanol, kerosene, xylene, heavy aromatic naphtha, light aromatic naphtha, mineral oil, toluene, diesel, propylene glycol, diethylene glycol, ethanol, and any combination thereof, and the water-soluble container comprises gelatin.

In some embodiments, the solvent is selected from the group consisting of isopropyl alcohol, light aromatic naphtha, mineral oil, toluene, and any combination thereof, and the water-soluble container comprises cellulose.

A method of transporting a treatment chemical is also provided by the present disclosure. The method includes transporting a container comprising the treatment chemical using a vehicle, such as a tanker truck or ship.

### Examples

Containers comprising polyvinyl alcohol, containers comprising gelatin, and containers comprising cellulose were filled with a solvent, sealed, and then stored for 3 days at about 40° C. to determine compatibility. In certain instances, the container degraded over the 3-day period and solvent leaked. In those instances, it was determined that the particular solvent and the particular container material (i.e., polyvinyl alcohol, gelatin, or cellulose) were incompatible.

The results of the tests conducted with polyvinyl alcohol containers can be seen in Table 1:

| | PVOH |
|---|---|
| Description | pouch |
| water | x |
| methanol | x |
| IPA | ✓ |
| Acetone | ✓ |
| Ethanol | x |
| MEG | x |
| propylene glycol (PG) | x |
| Diethylene glycol (DEG) | x |
| EGMBE | ✓ |
| 2-ethyl hexanol (2-EH) | ✓ |
| kerosene | ✓ |
| xylene | ✓ |
| heavy aromatic naphtha (HAN) | ✓ |
| light aromatic naphtha | ✓ |
| mineral oil | ✓ |
| toluene | ✓ |
| diesel | ✓ |
| 20% propylene glycol + 80% 2-ethyl hexanol | ✓ |
| 50% propylene glycol + 50% 2-ethyl hexanol | x |
| 20% Diethylene glycol + 80% 2-ethyl hexanol | ✓ |
| 50% Diethylene glycol + 50% 2-ethyl hexanol | x |

The results of the tests conducted with gelatin containers can be seen in Table 2:

| | gelatin |
|---|---|
| Description | capsule |
| water | x |
| methanol | x |
| IPA | ✓ |
| Acetone | ✓ |
| Ethanol | ✓ |
| MEG | x |
| propylene glycol (PG) | x |
| Diethylene glycol (DEG) | ✓ |
| EGMBE | ✓ |
| 2-ethyl hexanol (2-EH) | ✓ |
| kerosene | ✓ |
| xylene | ✓ |
| heavy aromatic naphtha (HAN) | ✓ |
| light aromatic naphtha | ✓ |
| mineral oil | ✓ |
| toluene | ✓ |
| diesel | ✓ |
| 20% propylene glycol + 80% 2-ethyl hexanol | ✓ |
| 50% propylene glycol + 50% 2-ethyl hexanol | ✓ |
| 20% Diethylene glycol + 80% 2-ethyl hexanol | ✓ |
| 50% Diethylene glycol + 50% 2-ethyl hexanol | ✓ |

The results of the tests conducted with cellulose containers can be seen in Table 3:

| | Cellulose |
|---|---|
| Description | packet |
| water | x |
| methanol | x |
| IPA | ✓ |
| Acetone | x |
| Ethanol | x |
| MEG | x |
| propylene glycol (PG) | x |
| Diethylene glycol (DEG) | x |
| EGMBE | x |
| 2-ethyl hexanol (2-EH) | x |
| kerosene | x |
| xylene | x |
| heavy aromatic naphtha (HAN) | x |
| light aromatic naphtha | ✓ |
| mineral oil | ✓ |
| toluene | ✓ |
| diesel | x |
| 20% propylene glycol + 80% 2-ethyl hexanol | x |
| 50% propylene glycol + 50% 2-ethyl hexanol | x |
| 20% Diethylene glycol + 80% 2-ethyl hexanol | x |
| 50% Diethylene glycol + 50% 2-ethyl hexanol | x |

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a treatment chemical” is intended to include “at least one treatment chemical” or “one or more treatment chemicals.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, component and/or ingredient disclosed herein or any combination of two or more of the elements, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “Including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

Unless specified otherwise, all molecular weights referred to herein are weight average molecular weights and all viscosities were measured at 25° C. with neat (not diluted) polymers.

As used herein, the term “about” refers to the cited value being within the errors arising from the standard deviation found in their respective testing measurements, and if those errors cannot be determined, then “about” may refer to, for example, within 5%, 4%, 3%, 2%, or 1% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A water-soluble container, comprising:
a composition comprising a treatment chemical and a solvent selected from the group consisting of isopropyl alcohol, acetone, ethylene glycol monobutyl ether (EGMBE), 2-ethyl hexanol, kerosene, xylene, heavy aromatic naphtha, light aromatic naphtha, mineral oil, toluene, diesel, propylene glycol, diethylene glycol, and any combination thereof, wherein the water-soluble container comprises a polyvinyl alcohol.

2. The water-soluble container of claim 1, wherein the solvent comprises about 20 wt % propylene glycol and about 80 wt % 2-ethyl hexanol or about 20 wt % diethylene glycol and about 80 wt % 2-ethyl hexanol.

3. The water-soluble container of claim 1, wherein the treatment chemical is selected from the group consisting of a hydrate inhibitor, an asphaltene inhibitor, a paraffin inhibitor, a demulsifier, a hydrogen sulfide scavenger, a foamer, a biocide, a scale inhibitor, a corrosion inhibitor, a drag reducing agent, and any combination thereof.

4. The water-soluble container of claim 3, wherein the corrosion inhibitor comprises an organic sulfur compound, an imidazoline, a carboxylic acid, a fatty acid amine condensate, a substituted fatty acid ester, a substituted aromatic amine, a phosphoric acid ester, a quaternary ammonium compound, a compound comprising multiple positive charges, or any combination thereof.

5. The water-soluble container of claim 3, wherein the corrosion inhibitor is selected from the group consisting of 2-mercaptoethanol, a diethylenetriamine (DETA) tall oil fatty acid (TOFA) imidazoline, a reaction product of triethylamine (TEA) and TOFA, a reaction product of TOFA and tetraethylenepentamine (TEPA), an alkyl pyridine, an ethoxylated branched nonylphenol phosphate ester, a benzy-(C₁₂ to C₁₈ linear alkyl)-dimethylammonium chloride, 5-carboxy-4-hexyl-2-cyclohexene octanoic acid, 6-carboxy-4-hexyl-2-cyclohexene octanoic acid, maleated TOFA, an acrylated DETA:TOFA imidazoline, and any combination thereof.

6. The water-soluble container of claim 1, further comprising a water-soluble salt weighting agent.

7. The water-soluble container of claim 1, wherein the treatment chemical is oil-soluble.

8. The water-soluble container of claim 1, wherein the composition is anhydrous.

9. The water-soluble container of claim 1, wherein the composition comprises a member selected from the group consisting of sodium bicarbonate, calcium carbonate, citric acid, oxalic acid, palmitic acid, tartaric acid, maleic acid, and any combination thereof.

10. A water-soluble container, comprising:
a composition comprising a treatment chemical and a solvent selected from the group consisting of isopropyl alcohol, acetone, EGMBE, 2-ethyl hexanol, kerosene, xylene, heavy aromatic naphtha, light aromatic naphtha, mineral oil, toluene, diesel, propylene glycol, diethylene glycol, ethanol, and any combination thereof, wherein the water-soluble container comprises gelatin.

11. The water-soluble container of claim 10, wherein the water-soluble container comprises a water-soluble polymer coating.

12. The water-soluble container of claim 10, wherein the solvent comprises about 20 wt % propylene glycol to about 50 wt % propylene glycol and about 80 wt % to about 50 wt % 2-ethyl hexanol or about 20 wt % diethylene glycol to about 50 wt % diethylene glycol and about 80 wt % 2-ethyl hexanol to about 50 wt % 2-ethyl hexanol.

13. The water-soluble container of claim 10, wherein the treatment chemical is selected from the group consisting of a hydrate inhibitor, an asphaltene inhibitor, a paraffin inhibitor, a demulsifier, a hydrogen sulfide scavenger, a foamer, a biocide, a scale inhibitor, a corrosion inhibitor, a drag reducing agent, and any combination thereof.

14. The water-soluble container of claim 10, further comprising a water-soluble salt weighting agent.

15. A water-soluble container, comprising:
a composition comprising a treatment chemical and a solvent selected from the group consisting of isopropyl alcohol, light aromatic naphtha, mineral oil, toluene, and any combination thereof, wherein the water-soluble container comprises cellulose.

16. The water-soluble container of claim 15, wherein the water-soluble container comprises paper, board stock, cardboard, corrugate, or any combination thereof.

17. The water-soluble container of claim 15, wherein the water-soluble container comprises a water-soluble polymer coating.

18. The water-soluble container of claim 15, wherein the treatment chemical is selected from the group consisting of a hydrate inhibitor, an asphaltene inhibitor, a paraffin inhibitor, a demulsifier, a hydrogen sulfide scavenger, a foamer, a biocide, a scale inhibitor, a corrosion inhibitor, a drag reducing agent, and any combination thereof.

19. A method of treating a subterranean reservoir or pipeline, comprising:
adding the water-soluble container of claim 1 to the subterranean reservoir or pipeline.

20. A method of treating a subterranean reservoir or pipeline, comprising:
adding the water-soluble container of claim 10 to the subterranean reservoir or pipeline.
